(19) United States
(12) Patent Application Publication
(10) Pub. No.: US 2010/0134455 A1
(43) Pub. Date: Jun. 3, 2010

(54) PLASMA DISPLAY DEVICE

(76) Inventors: Mitsuhiro Murata, Hyogo (JP); Yusuke Fukui, Osaka (JP); Toshikazu Wakabayashi, Osaka (JP); Hiroshi Asano, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/598,133

(22) PCT Filed: Apr. 14, 2009
(86) PCT No.: PCT/JP2009/001718

§ 371 Date: Oct. 29, 2009

(30) Foreign Application Priority Data
Apr. 18, 2008 (JP) 2008 108594

(51) Int. Cl. G06F 3/038

(52) U.S. Cl. 345/206; 345/213; 345/60

(57) ABSTRACT

In a plasma display panel, protective layer of front plate has base protective layer and particle layer. The base protective layer is formed of a thin film of a metal oxide containing at least one of magnesium oxide, strontium oxide, calcium oxide, and barium oxide. The particle layer is formed by sticking, to base protective layer, single-crystal particles of magnesium that have an NaCl crystal structure surrounded by specified two type orientation faces of a (100) face and a (111) face, or by specified three type orientation faces of a (100) face, a (110) face, and a (111) face. A panel driving circuit drives the panel in a manner that an initializing discharge for forming wall charge is caused in the first subfield of a plurality of subfields, and an address discharge for erasing the wall charge is caused in address periods of the plurality of subfields.

### TECHNICAL FIELD

The present invention relates to a plasma display device, which is an image display device using a plasma display panel.

### BACKGROUND ART

Among thin-type image display devices, a plasma display panel (hereinafter simply referred to as “panel”) allows high-speed display and can be easily upsized. Thus a plasma display panel is commercialized as a large-screen image display device.

The panel is formed of a front plate and a back plate bonded together. The front plate has the following elements:

a glass substrate;

display electrode pairs, each formed of a scan electrode and a sustain electrode, disposed on the glass substrate;

a dielectric layer formed to cover the display electrode pairs; and

a protective layer formed on the dielectric layer.

The protective layer is disposed to protect the dielectric layer from ion collision and to facilitate generation of discharge.

The back plate has the following elements:

a glass substrate;

data electrodes formed on the glass substrate;

a dielectric layer covering the data electrodes;

barrier ribs formed on the dielectric layer; and

phosphor layers formed between the barrier ribs and emitting light of red, green, and blue colors.

The front plate and the back plate are faced to each other so that the display electrode pairs and the data electrodes intersect with each other and sandwich a discharge space between the electrodes. The peripheries of the plates are sealed with a low melting glass. A discharge gas containing xenon is sealed into the discharge space. Discharge cells are formed in parts where the display electrode pairs are faced to the data electrodes.

In a plasma display device having a panel structured as above, a gas discharge is caused selectively in the respective discharge cells of the panel, and the ultraviolet light generated at this time excites the red, green, and blue phosphors so that light is emitted for color display.

A subfield method is typically used as a method for displaying images in a plasma display device using such a panel. In this method, one field period is formed of a plurality of subfields having predetermined luminance weights, and light emission and no light emission of discharge cells are controlled in each subfield for image display.

However, it is known that, when each discharge cell is lit or unlit optionally in each subfield, pronounced variations in gradation in a contour shape, so-called false contours, occur during the display of dynamic images. Then, a method for suppressing such false contours is proposed (see Patent Literature 1, for example). In this method, in order to suppress false contours, control is made for gradation display so that subfields in which the discharge cells are lit are successively disposed, and the subfields in which the discharge cells are unlit are also successively disposed. Although such a display method can suppress occurrence of false contours, the displayable gradation is limited and displaying smooth gradation is difficult.

In order to display smooth gradation, it is only necessary to increase the number of subfields forming one field period. In the above subfield method, one field period is formed of a plurality of subfields each having an initializing period, an address period, and a sustain period, and the combination of subfields of light emission provides gradation display. In order to increase the number of subfields forming one field period, reliable address operation needs to be performed within a short period of time. For this purpose, development of a panel that can be driven at high speed is promoted. Studies are also proceeding on a driving method and a driving circuit for displaying high quality images by taking full advantage of the panel.

The discharge characteristics of a panel depend largely on the characteristics of its protective layer. Particularly, in order to improve electron emission performance and charge retention performance that have considerable influence on whether or not the panel can be driven at high speed, many studies are made on the materials, structures, and manufacturing methods of the protective layer. For example, Patent Literature 2 discloses a plasma display device that has a panel and an electrode driving circuit. In this plasma display device, the panel includes a magnesium oxide layer that is made from magnesium vapor by gas-phase oxidation and has a cathode luminescence light emission peak at 200 nm to 300 nm. In address periods, the electrode driving circuit sequentially applies a scan pulse to one electrode of each one of display electrode pairs constituting the all display lines, and supplies, to the data electrodes, an address pulse that corresponds to the display lines applied with the scan pulse.

In recent years, a plasma display device having high definition as well as a large screen has been demanded. Further, high image display quality has been demanded. While the number of lines is increased as described above, the number of subfields for displaying smooth gradation needs to be secured. Thus the time assigned for the address operation per line tends to be further shortened. Therefore, in order to perform a reliable address operation within the assigned time, there is a demand for a panel capable of performing more stable address operation at higher speed than those of conventional arts, a driving method for the panel, and a plasma display device that has a driving circuit for implementing the method.

[Patent Literature 1] Japanese Patent Unexamined Publication No. H11-305726

[Patent Literature 2] Japanese Patent Unexamined Publication No. 2006-54158

### SUMMARY OF THE INVENTION

A plasma display device has a panel and a panel driving circuit. The panel has a front plate and a back plate faced to each other. The front plate has display electrode pairs formed on a first glass substrate, a dielectric layer formed to cover the display electrode pairs, and a protective layer formed on the dielectric layer. The back plate has data electrodes formed on a second glass substrate. Discharge cells are formed in positions where the display electrode pairs are faced to the data electrodes. The panel driving circuit drives the panel in a manner that a plurality of subfields are temporally disposed to form one field period. Each of the subfields has an address period for causing an address discharge, and a sustain period for causing a sustain discharge, in the discharge cells. The protective layer has a base protective layer and a particle layer. The base protective layer is formed of a thin film of a metal oxide containing at least one of magnesium oxide, strontium oxide, calcium oxide, and barium oxide. The particle layer is formed by sticking, to the base protective layer, single-crystal particles of magnesium oxide each having an NaCl crystal structure. The NaCl structure is surrounded by specified two type orientation faces of a (100) face and a (111) face, or specified three type orientation faces of a (100) face, a (110) face, and a (111) face. The panel driving circuit drives the panel in a manner that an initializing discharge for forming wall charge is caused in the first subfield of the plurality of subfields, and an address discharge for erasing the wall charge is caused in the address periods of the plurality of subfields.

### BRIEF DESCRIPTION OF THE DRAWINGS

FIG. 1 is an exploded perspective view showing a structure of a panel in accordance with a first exemplary embodiment of the present invention.

FIG. 2 is a sectional view showing a structure of a front plate of the panel.

FIG. 3A is a diagram showing an example of shapes of single-crystal particles of the panel.

FIG. 3B is a diagram showing another example of the shapes of the single-crystal particles of the panel.

FIG. 3C is a diagram showing yet another example of the shapes of the single-crystal particles of the panel.

FIG. 3D is a diagram showing still another example of the shapes of the single-crystal particles of the panel.

FIG. 4A is a diagram that shows an electron micrograph showing a shape of the single-crystal particles of magnesium oxide contained in a particle layer of the panel.

FIG. 4B is a diagram that shows an electron micrograph showing another shape of the single-crystal particles of magnesium oxide contained in the particle layer of the panel.

FIG. 4C is a diagram that shows an electron micrograph showing yet another shape of the single-crystal particles of magnesium oxide contained in the particle layer of the panel.

FIG. 5A is a diagram showing another shape of the single-crystal particles contained in the particle layer of the panel.

FIG. 5B is a diagram showing yet another shape of the single-crystal particles contained in the particle layer of the panel.

FIG. 5C is a diagram showing still another shape of the single-crystal particles contained in the particle layer of the panel.

FIG. 5D is a diagram showing still another shape of the single-crystal particles contained in the particle layer of the panel.

FIG. 5E is a diagram showing still another shape of the single-crystal particles contained in the particle layer of the panel.

FIG. 5F is a diagram showing still another shape of the single-crystal particles contained in the particle layer of the panel.

FIG. 6 is a diagram showing an electrode array of the panel.

FIG. 7 is a waveform chart of driving voltages to be applied to respective electrodes of the panel.

FIG. 8 is a diagram showing an electrode array of a panel in accordance with a second exemplary embodiment of the present invention.

FIG. 9 is a waveform chart of driving voltages to be applied to respective electrodes of the panel.

FIG. 10 is a circuit block diagram of a plasma display device in accordance with the first and second exemplary embodiments of the present invention.

FIG. 11 is a circuit diagram of a scan electrode driving circuit and a sustain electrode driving circuit of the plasma display device.

### REFERENCE MARKS IN THE DRAWINGS

10 Panel
20 Front plate
21 (First) glass substrate
22 Scan electrode
22a, 23a Transparent electrode
22b, 23b Bus electrode
23 Sustain electrode
24 Display electrode pair
25 Dielectric layer
26 Protective layer
26a Base protective layer
26b Particle layer
27 Single-crystal particle
30 Back plate
31 (Second) glass substrate
32 Data electrode
34 Barrier rib
35 Phosphor layer
41 Image signal processing circuit
42 Data electrode driving circuit
43 Scan electrode driving circuit
44 Sustain electrode driving circuit
45 Timing generating circuit
50, 80 Sustain pulse generating circuit
60 Initializing waveform generating circuit
70 Scan pulse generating circuit
100 Plasma display device

### DETAILED DESCRIPTION OF PREFERRED EMBODIMENTS

A plasma display device in accordance with exemplary embodiments of the present invention is demonstrated hereinafter with reference to the accompanying drawings.

### First Exemplary Embodiment

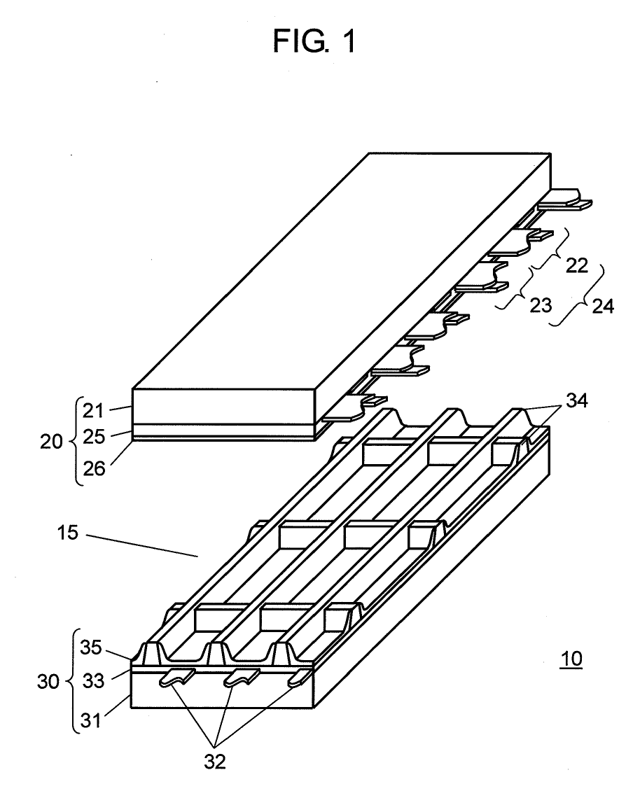

FIG. 1 is an exploded perspective view showing a structure of panel 10 in accordance with the first exemplary embodiment of the present invention. In panel 10, front plate 20 and back plate 30 are faced to each other, and the outer peripheries of the plates are sealed with a sealing material, a low-melting glass. A discharge gas containing xenon, or the like, is sealed into discharge space 15 inside of panel 10 at a pressure in the range of 400 Torr to 600 Torr.

A plurality of display electrode pairs 24, each formed of scan electrode 22 and sustain electrode 23, are formed parallel to each other on glass substrate (first glass substrate) 21 of front plate 20. Dielectric layer 25 is formed on glass substrate 21 so as to cover display electrode pairs 24. Further, protective layer 26 predominantly composed of magnesium oxide is formed on dielectric layer 25.

A plurality of data electrodes 32 are formed parallel to each other on glass substrate (second glass substrate) 31 of back plate 30 in the direction orthogonal to display electrode pairs 24. Dielectric layer 33 covers the data electrodes. Further, barrier ribs 34 are formed on dielectric layer 33. Phosphor layers 35 caused to emit red, green, or blue light by ultraviolet light are formed on dielectric layer 33 and the side faces of barrier ribs 34. A discharge cell is formed in a position where display electrode pair 24 intersects with data electrode 32. A set of discharge cells having red, green, and blue phosphor layers 35 forms a pixel for color display. Dielectric layer 33 is not essential, and may be omitted from the structure of the panel.

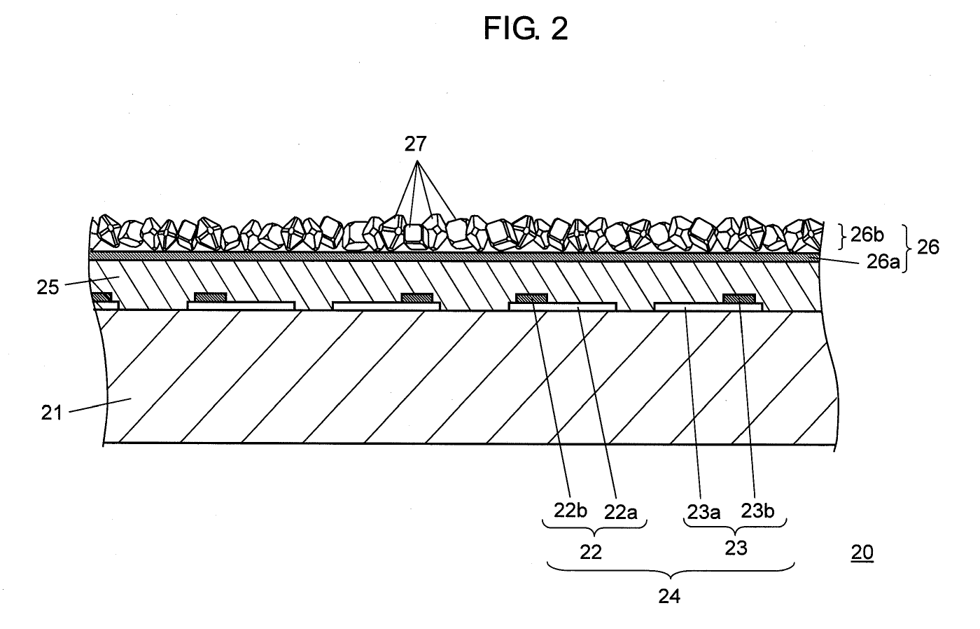

FIG. 2 is a sectional view showing a structure of front plate 20 of panel 10 in accordance with the first exemplary embodiment of the present invention. In FIG. 2, front plate 20 of FIG. 1 is vertically inverted. Display electrode pairs 24, each formed of scan electrode 22 and sustain electrode 23, are formed on glass substrate 21. Each scan electrode 22 is formed of transparent electrode 22a composed of indium tin oxide, tin oxide, or the like, and bus electrode 22b disposed on transparent electrode 22a. Similarly, each sustain electrode 23 is formed of transparent electrode 23a, and bus electrode 23b disposed on the transparent electrode. Bus electrodes 22b and bus electrodes 23b are disposed to impart conductivity in the longitudinal direction of respective transparent electrodes 22a and transparent electrodes 23a, and are formed of a conductive material predominantly composed of silver.

Dielectric layer 25 is formed by applying, for example, a low-melting glass predominantly composed of lead oxide, bismuth oxide, or phosphorous oxide by screen printing, die coating, or other methods, and firing the glass.

Protective layer 26 is formed on dielectric layer 25. Protective layer 26 is detailed hereinafter. The protective layer protects dielectric layer 25 from ion collision, and improves electron emission performance and charge retention performance that have considerable influence on driving speed. For this purpose, protective layer 26 has base protective layer 26a formed on dielectric layer 25, and particle layer 26b formed on base protective layer 26a.

Base protective layer 26a is a thin film that is formed by a thin film forming method, e.g. a vacuum deposition method and ion plating method, and is predominantly composed of magnesium oxide. The base protective layer has a thickness in the range of 0.3 μm to 1.0 μm, for example. Base protective layer 26a may also be formed of a metal oxide containing at least one of magnesium oxide, strontium oxide, calcium oxide, and barium oxide.

Particle layer 26b is formed by sticking single-crystal particles 27 of magnesium oxide so that the single-crystal particles are substantially uniformly distributed across the entire surface of base protective layer 26a.

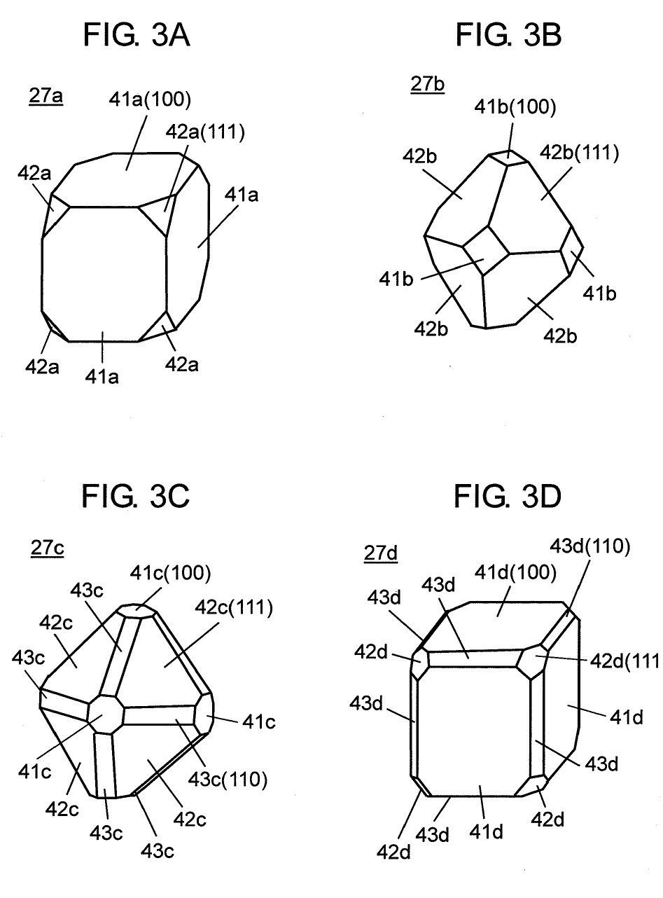

FIG. 3A is a diagram showing an example of shapes of single-crystal particles 27 of panel 10 in accordance with the exemplary embodiment of the present invention. The diagram shows single-crystal particle 27a shaped into a tetradecahedron that has truncated faces formed by cutting the vertexes of a hexahedron, which is a basic shape. Here, main faces 41a are (100) faces, and truncated faces 42a are (111) faces. FIG. 3B is a diagram showing another example of the shapes of single-crystal particles 27. The diagram shows single-crystal particle 27b shaped into a tetradecahedron that has truncated faces formed by cutting the vertexes of an octahedron, which is a basic shape. Here, main faces 42b are (111) faces, and truncated faces 41b are (100) faces. In this manner, each of single-crystal particle 27a and single-crystal particle 27b has an NaCl crystal structure that is surrounded by specified two type orientation faces of a (100) face and a (111) face.

FIG. 3C is a diagram showing yet another example of the shapes of single-crystal particles 27. The diagram shows single-crystal particle 27c shaped into an icosihexahedron that further has rhombic faces formed by cutting boundaries between (111) faces in the shape of single-crystal particle 27b. Here, main faces 42c are (111) faces, truncated faces 41c are (100) faces, and rhombic faces 43c are (110) faces. FIG. 3D is a diagram showing a still another example of the shapes of single-crystal particles 27. The diagram shows single-crystal particle 27d shaped into an icosihexahedron that further has rhombic faces formed by cutting ridge lines between adjacent (100) faces in the shape of single-crystal particle 27a. Here, main faces 41d are (100) faces, truncated faces 42d are (111) faces, and rhombic faces 43d are (110) faces. In this manner, each of single-crystal particle 27c and single-crystal particle 27d has an NaCl crystal structure that is surrounded by specified three type orientation faces of a (100) face, a (110) face, and a (111) face.

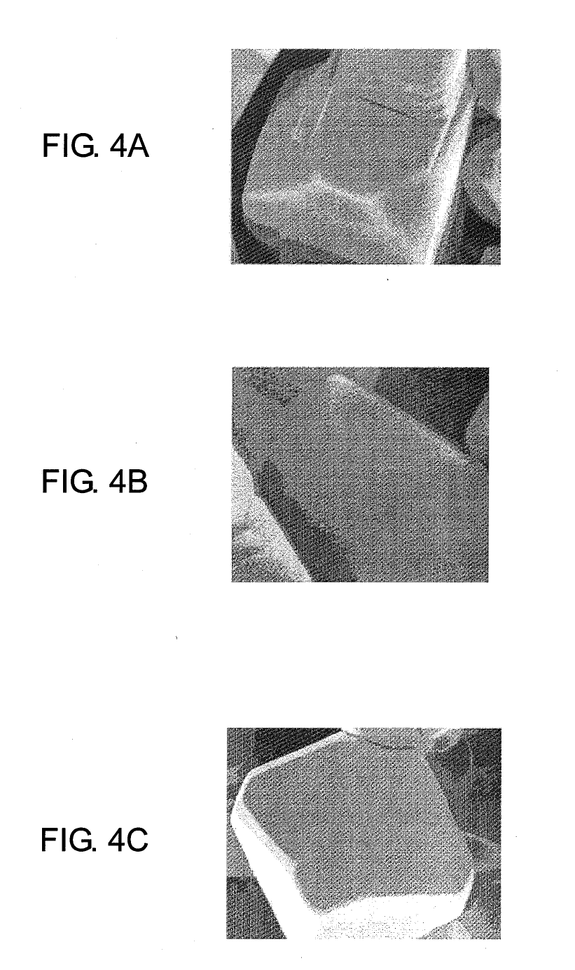

FIG. 4A is a diagram that shows an electron micrograph showing a shape of single-crystal particle 27a of magnesium oxide contained in particle layer 26b of panel 10 in accordance with the exemplary embodiment of the present invention. FIG. 4B is a diagram that shows an electron micrograph showing a shape of single-crystal particle 27b of magnesium oxide contained in particle layer 26b. FIG. 4C is a diagram that shows an electron micrograph showing single-crystal particle 27c of magnesium oxide contained in particle layer 26b. As shown by the micrographs, actually, single-crystal particles 27 having slightly deformed shapes are included.

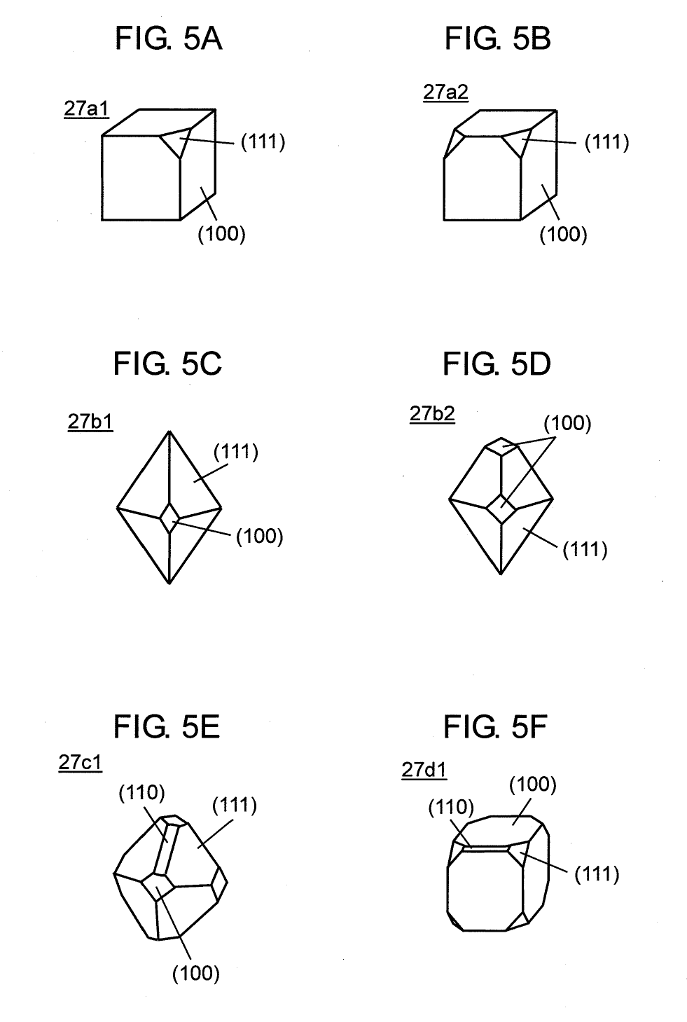

The truncated faces are not formed at all the vertexes. The rhombic faces are not formed along all the ridge lines. FIG. 5A is a diagram showing another shape of single-crystal particles 27 contained in particle layer 26b of panel 10 in accordance with the exemplary embodiment of the present invention. As a variation of single-crystal particle 27a, FIG. 5A shows a shape having one truncated face. As a variation of single-crystal particle 27a, FIG. 5B shows a shape having two truncated faces. FIG. 5C is a diagram showing still another shape of single-crystal particles 27 contained in particle layer 26b of panel 10 in accordance with the exemplary embodiment of the present invention. As a variation of single-crystal particle 27b, FIG. 5C shows a shape having one truncated face. As a variation of single-crystal particle 27b, FIG. 5D shows a shape having two truncated faces. FIG. 5E is a diagram showing still another shape of single-crystal particles 27 contained in particle layer 26b of panel 10 in accordance with the exemplary embodiment of the present invention. As a variation of single-crystal particle 27c, FIG. 5E shows a shape having six truncated faces and one rhombic face. FIG. 5F is a diagram showing still another shape of single-crystal particles 27 contained in particle layer 26b of panel 10 in accordance with the exemplary embodiment of the present invention. As a variation of single-crystal particle 27d, FIG. 5F shows a shape having eight truncated faces and one rhombic face.

As described above, the single crystal of magnesium oxide has an NaCl crystal structure of a cubic lattice, and has a (100) face, a (110) face, and a (111) face as main orientation faces. Among these faces, the (100) face is the densest face, and is resistant to adsorption of impure gases, e.g. vapor, hydrocarbon gas, and carbon dioxide gas, in a wide temperature range of low temperatures to high temperatures. For this reason, single-crystal particles 27 mainly having (100) faces can form particle layer 26b that has electron emission performance and charge retention performance stable and high in a wide temperature range.

On the other hand, the (111) face exhibits particularly high electron emission performance at room temperature or higher. Thus single-crystal particle 27 mainly having (111) faces is important in implementing a panel that can be driven at high speed.

The single-crystal particle that has an NaCl crystal structure surrounded by specified two type orientation faces of a (100) face and a (111) face, or the single-crystal particle that has an NaCl crystal structure surrounded by specified three type orientation faces of a (100) face, a (110) face, and a (111) face as described above can be produced by liquid phase methods.

Specifically, for example, such single crystal particles can be produced by evenly firing magnesium hydroxide, i.e. a precursor of magnesium oxide, in an oxygen-containing atmosphere at high temperatures, as described below.

### (Liquid Phase Method 1)

A small amount of acid is added to an aqueous solution of magnesium alkoxide or magnesium acetylacetone at a purity of 99.95% or higher. Thereby, the solution is hydrolyzed, so that a gel of magnesium hydroxide is prepared. The gel is fired in the air for dehydration. Thus the powder of single-crystal particles 27 is produced.

### (Liquid Phase Method 2)

An alkaline solution is added to an aqueous solution of magnesium nitrate at a purity of 99.95% or higher, to precipitate magnesium hydroxide. Next, the precipitate of magnesium hydroxide is separated from the aqueous solution, and fired in the air for dehydration. Thus the powder of single-crystal particles 27 is produced.

### (Liquid Phase Method 3)

Calcium hydroxide is added to an aqueous solution of magnesium chloride at a purity of 99.95% or higher, to precipitate magnesium hydroxide. Next, the precipitate of magnesium hydroxide is separated from the aqueous solution, and fired in the air for dehydration. Thus the powder of single-crystal particles 27 is produced.

Preferably, the firing temperature is 700° C. or higher; and more preferably, 1000° C. or higher. This is because the crystal faces grow insufficiently and have many defects, at firing temperatures lower than 700° C. The following tendencies are also observed. At firing temperatures equal to or higher than 700° C. and lower than 1500° C., single-crystal particle 27c or 27d surrounded by the specified three type orientation faces is produced at higher frequency. At firing temperatures equal to or higher than 1500° C., the (110) face shrinks and thus single-crystal particle 27a or 27b surrounded by the specified two type orientation faces are produced at higher frequency. However, at excessively high firing temperatures, occurrence of oxygen deficiency increases the defect in magnesium oxide crystals. Therefore, it is preferable to set the firing temperature to 1800° C. or lower.

The usable magnesium oxide precursors other than the above magnesium hydroxide include magnesium alkoxide, magnesium acetylacetone, magnesium nitrate, magnesium chloride, magnesium carbonate, magnesium sulfate, magnesium oxalate, and magnesium acetate. At least one of these magnesium compounds can be used. Preferably, the purity of the magnesium compound as a magnesium oxide precursor is 99.95% or higher; more preferably, 99.98% or higher. This is because when more impurity elements, e.g. alkali metal, boron, silicon, iron, and aluminum, are contained, particles fuse or sinter each other during firing, and thus highly-crystalline particles are difficult to grow.

Single-crystal particles 27 produced by these liquid phase methods are single-crystal particles 27 each surrounded by the specified two type orientation faces or the specified three type orientation faces, and the obtained crystals have few defects. Further, the liquid phase methods can provide powder that has relatively few variations in the particle diameters of single-crystal particles 27.

The crystal of magnesium oxide can also be produced by a gas-phase oxidation method. However, the magnesium oxide single-crystal particles produced by the gas-phase oxidation method have a disadvantage. That is, the (100) face mainly grows, and the other orientation faces are difficult to grow. The reasons are considered as follows. In production of magnesium oxide by the gas-phase oxidation method, while metal magnesium is heated to high temperatures in a tank filled with an inert gas, for example, a small amount of oxygen gas is made to flow. Thereby, the metal magnesium is directly oxidized, so that the crystal powder of magnesium oxide is produced. With such a process, (100) faces, i.e. the densest faces, grow preferentially.

However, in the liquid phase methods of the exemplary embodiment, magnesium hydroxide, i.e. a precursor of magnesium oxide, is a compound of hexagonal system, which is different in structure from the cubic system of magnesium oxide. Although the process of the crystal growth in which magnesium hydroxide is thermally decomposed to form a crystal of magnesium oxide is complicated, it is considered as follows. While the form of the hexagonal system is left, a single crystal of magnesium oxide is formed. Thus, as crystal faces, (100) faces and (111) faces, and further (110) faces are formed.

Similarly, magnesium compounds, such as magnesium alkoxide, magnesium nitrate, magnesium chloride, magnesium carbonate, magnesium sulfate, magnesium oxalate, magnesium acetate, are not of the cubic system. Thus, in a case where, as a magnesium oxide precursor, such a compound is thermally decomposed to form a magnesium oxide crystal, not only (100) faces but also (110) faces and (111) faces are considered to be formed while the (OR)₂ group, Cl₂ group, (NO₃)₂ group, CO₃ group, C₂O₄ group, or the like coordinated to the magnesium element is separated.

Further, the magnesium oxide single-crystal particles produced by the gas-phase oxidation method tend to have large variations in the particle diameters. For this reason, the manufacturing process of magnesium oxide by the gas-phase oxidation method requires a classification step of making the particle diameters uniform.

However, the liquid phase methods of the exemplary embodiment can provide single-crystal particles that have relatively uniform and large particle diameters. For example, the above liquid phase methods can provide crystal particles having diameters in the range of 0.3 μm to 2 μm. Thus the classification step for removing micro-particles can be omitted. Further, the liquid phase methods of the exemplary embodiment can provide crystals having large particle diameters. Thus each of the obtained crystals of magnesium oxide has a specific surface area smaller than that of the magnesium oxide crystal produced by the gas-phase oxidation method, and is highly adsorption-resistant.

As described above, particle layer 26b of the exemplary embodiment is formed by sticking, to base protective layer 26a, single-crystal particles 27 that have an NaCl crystal structure surrounded by specified two type orientation faces of a (100) face and a (111) face, or single-crystal particles 27d that have an NaCl crystal structure surrounded by specified three type orientation faces of a (100) face, a (110) face and a (111) face. With this structure, panel 10 has electron emission performance and charge retention performance both stably high in a wide temperature range, and can be driven at high speed.

Next, a description is provided for driving method of panel 10 in accordance with the exemplary embodiment.

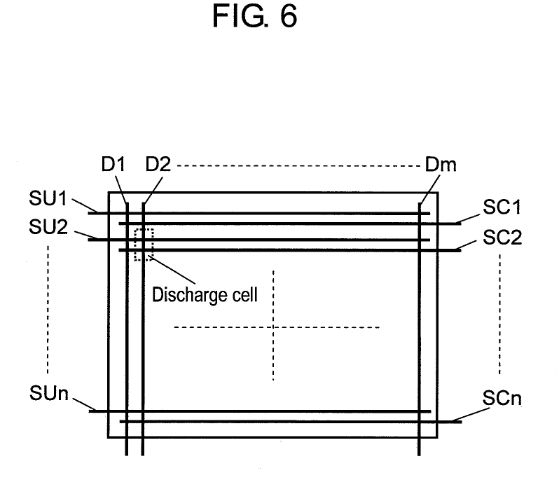

FIG. 6 is a diagram showing an electrode array of panel 10 in accordance with the first exemplary embodiment of the present invention. Panel 10 has n scan electrodes SC1 through SCn (scan electrodes 22 in FIG. 1) and n sustain electrodes SU1 through SUn (sustain electrodes 23 in FIG. 1) both long in the row (line) direction, and m data electrodes D1 through Dm (data electrodes 32 in FIG. 1) long in the column direction. A discharge cell is formed in the part where a pair of scan electrode SCi (i is 1 through n) and sustain electrode SUi intersects with one data electrode Dj (j is 1 through m). Thus m×n discharge cells are formed in the discharge space. For example, the number of discharge cells in a panel for use in a high-definition plasma display device is represented by the following values:

m=1920×3=5760, and n=1080

Next, a description is provided for driving voltage waveforms to be applied to the respective electrodes to drive panel 10. Panel 10 is driven by a subfield method in which a plurality of subfields are temporally disposed to form one field period. That is, one field period is divided into a plurality of subfields, and light emission and no light emission of each discharge cell are controlled in each subfield for gradation display. Each subfield has an address period, and a sustain period. The first subfield has an initializing period.

In the initializing period, an initializing discharge is caused to form wall charge necessary for a sustain discharge to light the discharge cells, on the respective electrodes. At this time, wall charge necessary for an address discharge is also formed. In the address period, the address discharge is caused in the discharge cells to be unlit, to erase the wall charge necessary for a sustain discharge. In the sustain period, sustain pulses corresponding in number to a luminance weight are applied alternately to the display electrode pairs, thereby causing a sustain discharge for light emission in the discharge cells having undergone no address discharge.

In this manner, the driving method of the exemplary embodiment is characterized in that the first subfield has an initializing period, the subfields thereafter have no initializing period, and an address operation is performed in the discharge cells to be unlit. In the discharge cells having undergone an initializing operation in the initializing period of the first subfield and undergoing no address operation thereafter, a sustain discharge is successively caused for light emission. In the discharge cells having undergone an address operation once, no sustain discharge is caused until the next initializing operation is performed. In this manner, control for gradation display is made so that the subfields in which the discharge cells are lit are successively disposed and the subfields (SFs) in which the discharge cells are unlit are also successively disposed. In the subfield methods, such a driving method by the above control is simply referred to as “successive driving method” hereinafter.

In the exemplary embodiment, one field is divided into 14 subfields (the first SF, and the second SF through the 14th SF). The respective subfields have luminance weights of 1, 1, 1, 1, 3, 5, 5, 8, 16, 16, 20, 22, 28, and 64 in this order, for example. The first SF is a subfield that has an initializing period. Each of the second SF through the 14th SF is a subfield that has no initializing period. Hereinafter, the successive driving method of the exemplary embodiment is detailed.

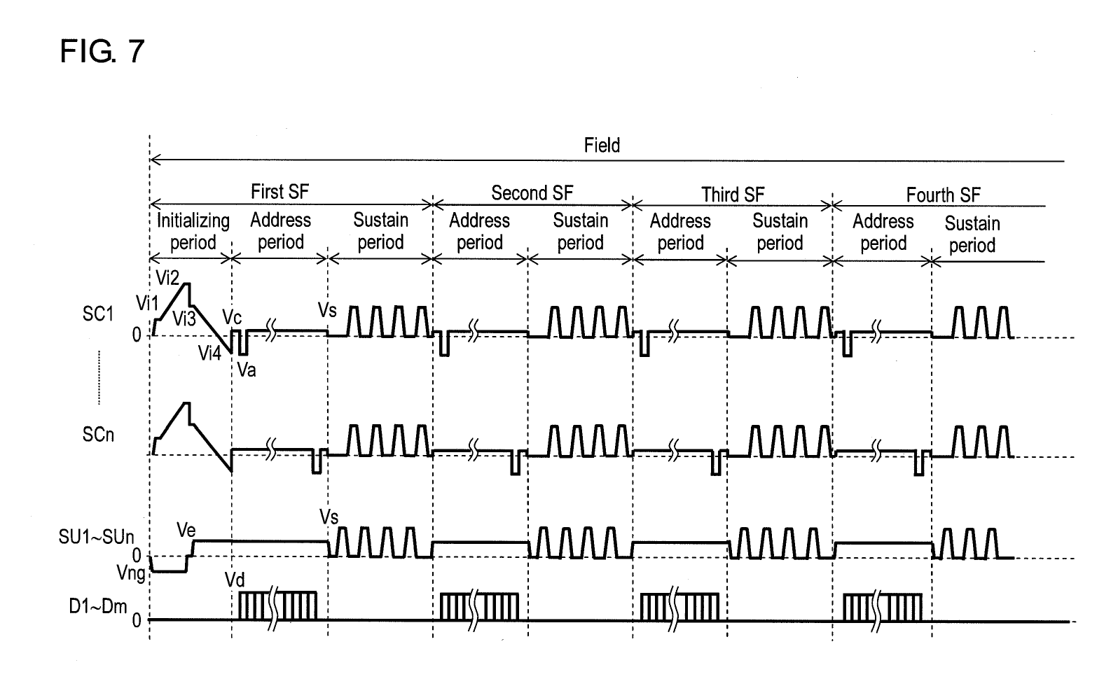

FIG. 7 is a waveform chart of driving voltages to be applied to respective electrodes of panel 10 in accordance with the first exemplary embodiment of the present invention. First, a description is provided for the first SF, which has an initializing period.

In the first half of the initializing period of the first SF, first, 0 (V) is applied to each of data electrodes D1 through Dm, voltage Vng is applied to sustain electrodes SU1 through SUn, and a ramp waveform voltage is applied to scan electrodes SC1 through SCn. Here, the ramp waveform voltage gradually rises from voltage Vi1, which is equal to or lower than a discharge start voltage, toward voltage Vi2, which exceeds the discharge start voltage, with respect to sustain electrodes SU1 through SUn.

While this ramp waveform voltage is rising, a weak initializing discharge occurs between scan electrodes SC1 through SCn and sustain electrodes SU1 through SUn, and between the scan electrodes and data electrodes D1 through Dm. Then, negative wall voltage accumulates on scan electrodes SC1 through SCn. Positive wall voltage accumulates on data electrodes D1 through Dm and sustain electrodes SU1 through SUn. Here, the wall voltages on the electrodes represent the voltages generated by wall charge that are accumulated on the dielectric layers covering the electrodes, the protective layer, and the phosphor layers, for example. In this initializing discharge, wall voltages are excessively accumulated prior to the subsequent latter half of the initializing period in which the wall voltages are optimized.

Next, in the latter half of the initializing period, voltage Ve is applied to sustain electrodes SU1 through SUn, and a ramp waveform voltage is applied to scan electrodes SC1 through SCn. Here, the ramp waveform voltage gradually falls from voltage Vi3, which is equal to or lower than the discharge start voltage, toward voltage Vi4, which exceeds the discharge start voltage, with respect to sustain electrodes SU1 through SUn. During this application, a weak initializing discharge occurs between scan electrodes SC1 through SCn and sustain electrodes SU1 through SUn, and between the scan electrodes and data electrodes D1 through Dm. This weak discharge optimizes the excess negative wall voltage on scan electrodes SC1 through SCn and the excess positive wall voltage on sustain electrodes SU1 through SUn, and forms wall charge necessary for a sustain discharge. This weak discharge also optimizes the excess positive wall voltage on data electrodes D1 through Dm and forms the wall charge necessary for an address discharge. Thus the initializing operation is completed.

In the subsequent address period, voltage Ve is applied to sustain electrodes SU1 through SUn, and Voltage Vc is applied to scan electrodes SC1 through SCn.

Next, negative scan pulse voltage Va is applied to scan electrode SC1 in the first line. Positive address pulse voltage Vd is applied to data electrode Dk (k is 1 through m) of a discharge cell to be unlit in the first line, among data electrodes D1 through Dm. At this time, the voltage difference in the intersecting part between data electrode Dk and scan electrode SC1 is obtained by adding the difference in an externally applied voltage (voltage Vd−voltage Va) to the difference between the wall voltage on data electrode Dk and the wall voltage on scan electrode SC1. Thus the voltage difference exceeds the discharge start voltage. Then, an address discharge occurs between data electrode Dk and scan electrode SC1, and between sustain electrode SU1 and scan electrode SC1. Thereby, the wall voltage on scan electrode SC1 and the wall voltage on sustain electrode SU1 are erased. Erasing the wall voltages at this time means that the wall voltages are reduced to a level at which no sustain discharge occurs in the sustain period to be described later. Negative wall voltage is accumulated on data electrode Dk.

Here, the time after application of scan pulse voltage Va and address pulse voltage Vd until generation of an address discharge is referred to as “discharge delay time”. If a panel has low electron emission performance and thus a long discharge delay time, time periods during which scan pulse voltage Va and address pulse voltage Vd are applied for a reliable address operation, i.e. a scan pulse width and an address pulse width, need to be set longer. Thus the address operation cannot be performed at high speed. If the panel has low charge retention performance, the values of scan pulse voltage Va and address pulse voltage Vd need to be set higher in order to compensate for a decrease in the wall voltages. However, because panel 10 of the exemplary embodiment has high electron emission performance, the scan pulse width and address pulse width can be set shorter than those of the conventional panel, and the address operation can be performed stably at high speed. Further, because panel 10 of the exemplary embodiment has high charge retention performance, the values of scan pulse voltage Va and address pulse voltage Vd can be set lower than those of the conventional panel.

In this manner, the address operation is performed to cause the address discharge in the discharge cells to be unlit in the first line and to erase wall voltages on the corresponding electrodes. On the other hand, the voltage in the intersecting parts between data electrodes D1 through Dm applied with no address pulse voltage Vd and scan electrode SC1 does not exceed the discharge start voltage. Thus no address discharge occurs, and the wall voltage at the completion of the initializing period is maintained. The above address operation is repeated until the operation reaches the discharge cells in the n-th line, and the address period is completed.

In the subsequent sustain period, first, 0 (V) is applied to scan electrodes SC1 through SCn, and positive sustain pulse voltage Vs is applied to sustain electrodes SU1 through SUn. Then, in the discharge cells having undergone no address discharge, the voltage difference between sustain electrode SUi and scan electrode SCi is obtained by adding sustain pulse voltage Vs to the difference between the wall voltage on sustain electrode SUi and the wall voltage on scan electrode SCi. Thus the voltage difference exceeds the discharge start voltage.

Then, a sustain discharge occurs between scan electrode SCi and sustain electrode SUi, and ultraviolet light generated at this time causes phosphor layers 35 to emit light. Positive wall voltage accumulates on scan electrode SCi, and negative wall voltage accumulates on sustain electrode SUi. In the discharge cells having undergone the address discharge in the address period, no sustain discharge occurs.

Subsequently, sustain pulse voltage Vs is applied to scan electrodes SC1 through SCn, and 0 (V) is applied to sustain electrodes SU1 through SUn. In the discharge cell having undergone the sustain discharge, the voltage difference between scan electrode SCi and sustain electrode SUi exceeds the discharge start voltage, so that a sustain discharge is caused between scan electrode SCi and sustain electrode SUi again. Negative wall voltage accumulates on scan electrode SCi, and positive wall voltage accumulates on sustain electrode SUi.

Similarly, sustain pulses corresponding in number to the luminance weight are applied alternately to sustain electrodes SU1 through SUn and scan electrodes SC1 through SCn to cause a potential difference between the electrodes of each display electrode pair. Thereby, the sustain discharge is continued in the discharge cells having undergone no address discharge in the address period.

The subsequent second SF is a subfield that has no initializing period. In the address period of the second SF, voltage Ve is applied to sustain electrodes SU1 through SUn, and voltage Vc is applied to scan electrodes SC1 through SCn. Next, negative scan pulse voltage Va is applied to scan electrode SC1 in the first line, and positive address pulse voltage Vd is applied to data electrode Dk of a discharge cell to be unlit in the first line, among data electrodes D1 through Dm.

Then, in the discharge cells having undergone a sustain discharge in the immediately preceding first SF, an address discharge occurs between data electrode Dk and scan electrode SC1, and between sustain electrode SU1 and scan electrode SC1. Thus the wall voltage on scan electrode SC1 and the wall voltage on sustain electrode SU1 are erased. In this manner, an address operation is performed to cause an address discharge in the discharge cells to be unlit in the first line and to erase the wall voltages on the corresponding electrodes. On the other hand, in the discharge cells having already undergone an address discharge in the address period after the initializing period and having undergone no sustain discharge in the immediately preceding first SF, and in the discharge cells applied with no address pulse voltage Vd, the voltage at the intersecting parts between data electrodes D1 through Dm and scan electrode SC1 does not exceed the discharge start voltage. Thus no address discharge occurs in these discharge cells. The above address operation is repeated until the operation reaches the discharge cells in the n-th line, and the address period is completed.

In the subsequent sustain period, 0 (V) is applied to scan electrodes SC1 through SCn, and positive sustain pulse voltage Vs is applied to sustain electrodes SU1 through SUn. Then, in the discharge cells having undergone a sustain discharge in the sustain period of the immediately preceding first SF and having undergone no address discharge, a sustain discharge occurs between scan electrode SCi and sustain electrode SUi. Thus the corresponding discharge cells are lit. In the discharge cells having already undergone an address discharge in the address period after the initializing period and having undergone no sustain discharge in the immediately preceding first SF, or the discharge cells having undergone an address discharge, no sustain discharge occurs.

Subsequently, sustain pulse voltage Vs is applied to scan electrodes SC1 through SCn, and 0 (V) is applied to sustain electrode SU1 through SUn. Then, in the discharge cells having undergone the sustain discharge, a sustain discharge occurs again. Positive wall voltage accumulates on sustain electrode SUi, and negative wall voltage accumulates on scan electrode SCi. Thereafter, similarly, sustain pulses corresponding in number to a luminance weight are applied alternately to sustain electrodes SU1 through SUn and scan electrodes SC1 through SCn, to cause a potential difference between the electrodes of each display electrode pair. Thereby, the sustain discharge is continued.

The driving voltage waveforms and the operation of the panel in the third SF through the 14th SF are substantially similar to those in the second SF, except for the numbers of sustain pulses.

That is, in each of the address periods of the third SF through the 14th SF, voltage Ve is applied to sustain electrodes SU1 through SUn, and voltage Vc is applied to scan electrodes SC1 through SCn. Next, negative scan pulse voltage Va is applied to scan electrode SC1 in the first line, and positive address pulse voltage Vd is applied to data electrode Dk of a discharge cell to be unlit in the first line, among data electrodes D1 through Dm.

Then, in the discharge cells having undergone a sustain discharge in the immediately preceding subfield, an address discharge occurs. Thus the wall voltage on scan electrode SC1 and the wall voltage on sustain electrode SU1 are erased. On the other hand, in the discharge cells having already undergone an address discharge in the address period after the initializing period and having undergone no sustain discharge in the immediately preceding subfield, and in the discharge cells having undergone no address pulse voltage Vd, no address discharge occurs. The above address operation is repeated until the operation reaches the discharge cells in the n-th line, and the address period is completed.

In the subsequent sustain period, sustain pulses corresponding in number to the luminance weight are applied alternately to sustain electrodes SU1 through SUn and scan electrodes SC1 through SCn. Then, in the discharge cells having undergone a sustain discharge in the sustain period of the immediately preceding subfield and having undergone no address discharge, a sustain discharge occurs and thus the corresponding cells are lit. On the other hand, in the discharge cells having already undergone an address discharge in the address period after the initializing period and having undergone no sustain discharge in the preceding subfield, or the discharge cells having undergone an address discharge, no sustain discharge occurs.

In the exemplary embodiment, scan electrodes SC1 through SCn are applied with voltage Vi1 of 130 (V), voltage Vi2 of 380 (V), voltage Vi3 of 200 (V), voltage Vi4 of −25 (V), voltage Vc of 80 (V), voltage Va of −50 (V), and voltage Vs of 200 (V). Sustain electrodes SU1 through SUn are applied with voltage Vng of −50 (V), voltage Ve of 50 (V), and voltage Vs of 200 (V). Data electrodes D1 through Dm are applied with voltage Vd of 67 (V). The gradient of the up-ramp waveform voltage to be applied to scan electrodes SC1 through SCn is 1.0 V/μ, and the gradient of the down-ramp waveform voltage to be applied to the scan electrodes is −1.3V/μ. Each of the scan pulse and the address pulse has a pulse width of 1.0 μs. However, these voltages are not limited to the above values. It is preferable to set optimum values according to the discharge characteristics of the panel and the specifications of the plasma display device.

As described above, the driving method of the exemplary embodiment is a successive driving method. That is, in the discharge cells having undergone an initializing operation in the initializing period of the first subfield, and undergoing no address operation thereafter, a sustain discharge is successively caused for light emission. In the discharge cells having undergone an address operation once, no sustain discharge is caused until the next initializing operation is performed.

In this manner, in the exemplary embodiment, by taking full advantage of the panel that has high electron emission performance and can be driven at high speed, the address period is shortened and the number of subfields necessary for gradation display is secured. Further, panel 10 is driven by a successive driving method. Thereby, images of high quality without false contours can be displayed.

Further, panel 10 of the exemplary embodiment has high charge retention performance. Thus the values of scan pulse voltage Va and address pulse voltage Vd can be set lower than those of the conventional panel. However, even in panel 10 of the exemplary embodiment, the wall charge slightly decreases. Thus, as the number of discharge electrode pairs is increased or the number of subfields is increased, the voltages of scan pulse voltage Va and address pulse voltage Vd tend to rise. Next, a successive driving method for suppressing the rise in these voltages is described.

### Second Exemplary Embodiment

The panel of the second exemplary embodiment of the present invention is identical in structure with panel 10 of the first exemplary embodiment, and the description thereof is omitted. The second exemplary embodiment largely differs from the first exemplary embodiment in the driving method of panel 10, namely, a successive driving method for suppressing a rise in voltages of scan pulse voltage Va and address pulse voltage Vd.

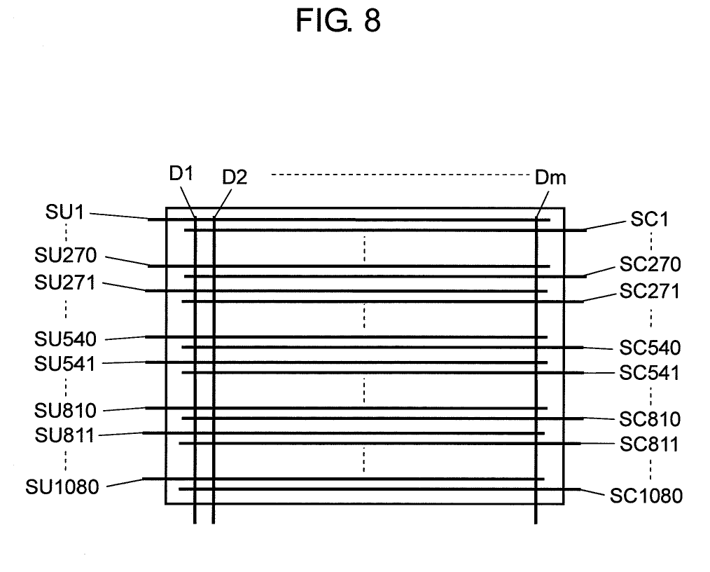

FIG. 8 is a diagram showing an electrode array of panel 10 in accordance with the second exemplary embodiment of the present invention. Panel 10 has an electrode array identical with that of the first exemplary embodiment. The panel has n scan electrodes SC1 through SCn (scan electrodes 22 in FIG. 1) and n sustain electrodes SU1 through SUn (sustain electrodes 23 in FIG. 1) both long in the row (line) direction, and m data electrodes D1 through Dm (data electrodes 32 in FIG. 1) long in the column direction. A discharge cell is formed in the part where a pair of scan electrode SCi (i is 1 through n) and sustain electrode SUi intersects with one data electrode Dj (j is 1 through m). Thus m×n discharge cells are formed in the discharge space. For example, the number of discharge cells is represented by the following values:

m=1920×3=5760, and n=1080

The number of display electrode pairs is not specifically limited. The description is provided for n=1080, in the second exemplary embodiment.

Further, n scan electrodes SC1 through SC1080 and n sustain electrodes SU1 through SU1080 form 1080 display electrode pairs, and these display electrode pairs are divided into a plurality of display electrode pair groups. In the description of the second exemplary embodiment, the panel is divided into four groups of display electrode pairs in the direction from top to bottom of the panel. The four groups are referred to as a first display electrode pair group, a second display electrode pair group, a third display electrode pair group, and a fourth display electrode pair group in the order starting from the display electrode pair disposed at the top of the panel. That is, each group has 270 scan electrodes and 270 sustain electrodes as described below. Scan electrodes SC1 through SC270, and sustain electrodes SU1 through SU270 belong to the first display electrode pair group. Scan electrodes SC271 through SC540, and sustain electrodes SU271 through SU540 belong to the second display electrode pair group. Scan electrodes SC541 through SC810, and sustain electrodes SU541 through SU810 belong to the third display electrode pair group. Scan electrodes SC811 through SC1080, and sustain electrodes SU811 through SU1080 belong to the fourth display electrode pair group.

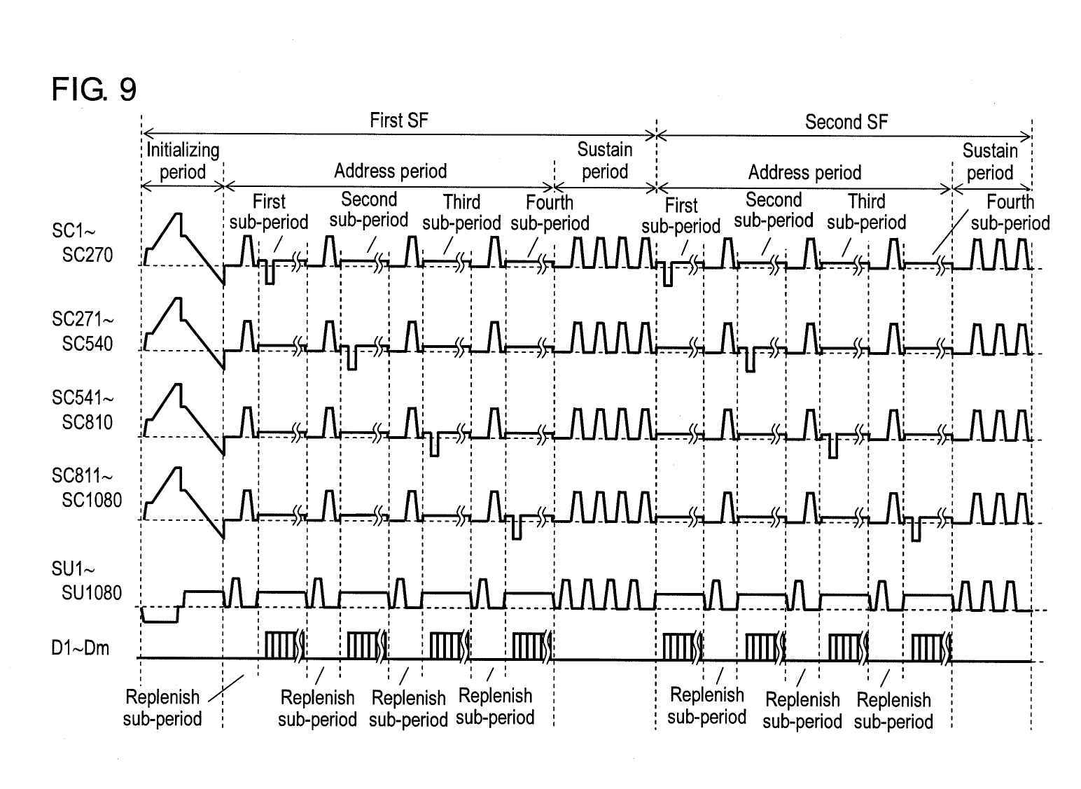

FIG. 9 shows a waveform chart of driving voltages to be applied to respective electrodes of panel 10 in accordance with the second exemplary embodiment of the present invention. FIG. 9 shows the first SF and the second SF.

The initializing period of the first SF is similar to that of the first exemplary embodiment, and the description thereof is omitted.

The subsequent address period is divided into four address sub-periods (a first sub-period, a second sub-period, a third sub-period, and a fourth sub-period) corresponding to the four display electrode pair groups. Before each address sub-period, a replenish sub-period for replenishing wall charge is disposed.

In the first replenish sub-period of the address period, first, 0 (V) is applied to scan electrodes SC1 through SCn, and positive sustain pulse voltage Vs is applied to sustain electrodes SU1 through SUn. Then, a discharge occurs between scan electrode SCi and sustain electrode SUi. Sequentially, sustain pulse voltage Vs is applied to scan electrodes SC1 through SCn, and 0 (V) is applied to sustain electrodes SU1 through SUn. Then, a discharge occurs between scan electrode SCi and sustain electrode SUi again. Such a discharge in the replenish sub-period (hereinafter referred to as “replenish discharge”) is a discharge similar to a sustain discharge, and occurs irrespective of image display. Further, even if the wall charge on data electrodes D1 through Dm decreases for some causes, the wall charge on data electrodes D1 through Dm is replenished by the replenish discharge. Thus the voltages of scan pulse voltage Va and address pulse voltage Vd will never rise in the subsequent first sub-period.

In the subsequent address period, i.e. the first sub-period, voltage Ve is applied to sustain electrodes SU1 through SUn, and voltage Vc is applied to scan electrodes SC1 through SCn. Next, scan pulse voltage Va is applied to scan electrode SC1 in the first line, and address pulse voltage Vd is applied to data electrode Dk of a discharge cell to be unlit in the first line, among data electrodes D1 through Dm. Then, an address discharge occurs between data electrode Dk and scan electrode SC1, and between sustain electrode SU1 and scan electrode SC1. Thus the wall voltage on scan electrode SC1 and the wall voltage on sustain electrode SU1 are erased. The above address operation is repeated until the operation reaches the discharge cells in the 270th line belonging to the first display electrode pair group, and the first sub-period is completed.

In the subsequent replenish sub-period, first, 0 (V) is applied to scan electrodes SC1 through SCn, and positive sustain pulse voltage Vs is applied to sustain electrodes SU1 through SUn to cause a replenish discharge. Next, sustain pulse voltage Vs is applied to scan electrodes SC1 through SCn, and 0 (V) is applied to sustain electrodes SU1 through SUn to cause a replenish discharge. In the first sub-period, one-fourth of the whole discharge cells undergo the address operation. Thus the amount of decrease in wall charge is approximately one-fourth of the amount of decrease in wall charge in an address period in the driving method of the first exemplary embodiment. Before wall charge has further decreased, the wall charge on data electrodes D1 through Dm is replenished by a replenish discharge. Thus, in the subsequent second sub-period, the voltages of scan pulse voltage Va and address pulse voltage Vd will never rise.

In the subsequent address period, i.e. the second sub-period, voltage Ve is applied to sustain electrodes SU1 through SUn, and voltage Vc is applied to scan electrodes SC1 through SCn. Next, scan pulse voltage Va is applied to scan electrode SC271 in the 271st line, and address pulse voltage Vd is applied to data electrode Dk of a discharge cell to be unlit in the 271st line, among data electrodes D1 through Dm. Then, an address discharge occurs, so that the wall voltage on scan electrode SC271 and the wall voltage on sustain electrode SU271 are erased. The above address operation is repeated in the discharge cells in the 271st line to the 540th line belonging to the second display electrode pair group, and the second sub-period is completed.

In the subsequent replenish sub-period, first, 0 (V) is applied to scan electrodes SC1 through SCn, and positive sustain pulse voltage Vs is applied to sustain electrodes SU1 through SUn to cause a replenish discharge. Next, sustain pulse voltage Vs is applied to scan electrodes SC1 through SCn, and 0 (V) is applied to sustain electrodes SU1 through SUn to cause a replenish discharge. Also in the second sub-period, one-fourth of the whole discharge cells undergo the address operation. Thus the amount of decrease in wall charge is approximately one-fourth of the amount of decrease in wall charge in an address period in the driving method of the first exemplary embodiment. Before wall charge has further decreased, the wall charge on data electrodes D1 through Dm are replenished by a replenish discharge. Thus, in the subsequent third sub-period, the voltages of scan pulse voltage Va and address pulse voltage Vd will never rise.

In the subsequent third sub-period, voltage Ve is applied to sustain electrodes SU1 through SUn, and voltage Vc is applied to scan electrodes SC1 through SCn. Next, scan pulse voltage Va is applied to scan electrode SC541 in the 541st line, and address pulse voltage Vd is applied to data electrode Dk of a discharge cell to be unlit in the 541st line, among data electrodes D1 through Dm. Then, an address discharge occurs, so that the wall voltage on scan electrode SC541 and the wall voltage on sustain electrode SU541 are erased. The above address operation is repeated in the discharge cells in the 541st line to the 810th line belonging to the third display electrode pair group, and the third sub-period is completed. Also in the subsequent replenish sub-period, similar to the other replenish sub-periods, first, 0 (V) is applied to scan electrodes SC1 through SCn, and positive sustain pulse voltage Vs is applied to sustain electrodes SU1 through SUn to cause a replenish discharge. Next, sustain pulse voltage Vs is applied to scan electrodes SC1 through SCn, and 0 (V) is applied to sustain electrodes SU1 through SUn to cause a replenish discharge.

In the fourth sub-period, voltage Ve is applied to sustain electrodes SU1 through SUn, and voltage Vc is applied to scan electrodes SC1 through SCn. Next, scan pulse voltage Va is applied to scan electrode SC811 in the 811th line, and address pulse voltage Vd is applied to data electrode Dk of a discharge cell to be unlit in the 811th line, among data electrodes D1 through Dm. Then, an address discharge occurs, so that the wall voltage on scan electrode SC811 and the wall voltage on sustain electrode SU811 are erased. The above address operation is repeated in the discharge cells in the 811th line to the 1080th line belonging to the fourth display electrode pair group. Thus the address period is completed.

The sustain period of the first SF is similar to that of the first exemplary embodiment, and the description thereof is omitted.

Also the subsequent address period of the second SF is divided into four address sub-periods (a first sub-period, a second sub-period, a third sub-period, and a fourth sub-period) corresponding to the four display electrode pair groups. Before each address sub-period, a replenish sub-period for replenishing wall charge is disposed. However, as the replenish discharge before the first sub-period, the sustain discharge in the sustain period of the first SF can be used. Thus this replenish discharge is omitted in the second exemplary embodiment. The other sub-periods, i.e. a first sub-period, a replenish sub-period, a second sub-period, a replenish sub-period, a third sub-period, a replenish sub-period, and a fourth sub-period, are similar to the first sub-period, the replenish sub-period, the second sub-period, the replenish sub-period, the third sub-period, the replenish sub-period, and the fourth sub-period, respectively, of the first SF.

The sustain period of the second SF is similar to that of the first exemplary embodiment, and the description thereof is omitted. The third SF through the 14th SF are similar to the second SF, except for the numbers of sustain pulses.

As described above, in the second exemplary embodiment, panel 10 is driven in the following structure. Display electrode pairs 24 are divided into four display electrode pair groups, and the address period is divided into four address sub-periods corresponding to the four display electrode pair groups. Before address sub-periods, replenish sub-periods for replenishing wall charge are disposed. With this structure, one-fourth of the whole discharge cells undergo an address operation in each address sub-period. Thus the amount of decrease in wall charge is approximately one-fourth of the amount of decrease in wall charge in an address period in the driving method of the first exemplary embodiment. Before wall charge has further decreased, the wall charge on data electrodes D1 through Dm are replenished by a replenish discharge. Thus, in each of the subsequent address sub-periods, the voltages of scan pulse voltage Va and address pulse voltage Vd will never rise. As a result, the rise in these voltages can be suppressed.

In the second exemplary embodiment, panel 10 is driven in the following structure. Display electrode pairs 24 are divided into four display electrode pair groups, and each address period is divided into four address sub-periods corresponding to the four display electrode pair groups. In the first SF, a replenish sub-period for replenishing wall charge is disposed before each address sub-period. In each of the second SF through the 14th SF, replenish sub-periods for replenishing wall charge are disposed before address sub-periods except the first sub-period. However, the present invention is not limited to this structure. The following structure can be used for driving the panel. According to the characteristics of the panel, for example, display electrode pairs 24 are divided into a plurality of display electrode pair groups, and each address period is divided into a plurality of address sub-periods corresponding to the plurality of display electrode pair groups. Further, a replenish sub-period for replenishing wall charge is disposed before at least one of the address sub-periods.

In the description of the second exemplary embodiment, an address operation is performed on the first display electrode pair group in the first sub-period, on the second display electrode pair group in the second sub-period, on the third display electrode pair group in the third sub-period, and on the fourth display electrode pair group in the fourth sub-period. However, the present invention is not limited to this structure. In order to make the display luminance of each display electrode pair group uniform, it is preferable to change the combination of the display electrode pair groups and the address sub-periods, for each field. For example, in the first field, an address operation is performed on the first display electrode pair group in the first sub-period, on the second display electrode pair group in the second sub-period, on the third display electrode pair group in the third sub-period, and on the fourth display electrode pair group in the fourth sub-period. In the second field, an address operation is performed on the first display electrode pair group in the second sub-period, on the second display electrode pair group in the third sub-period, on the third display electrode pair group in the fourth sub-period, and on the fourth display electrode pair group in the first sub-period. In the third field, an address operation is performed on the first display electrode pair group in the third sub-period, on the second display electrode pair group in the fourth sub-period, on the third display electrode pair group in the first sub-period, and on the fourth display electrode pair group in the second sub-period. In the fourth field, an address operation is performed on the first display electrode pair group in the fourth sub-period, on the second display electrode pair group in the first sub-period, on the third display electrode pair group in the second sub-period, and on the fourth display electrode pair group in the third sub-period. In this manner, the combination of the display electrode pair groups and the address sub-periods is cyclically changed for each field. Thereby, the display luminance of each display electrode pair group can be made uniform.

Next, a description is provided for an example of a driving circuit for generating the driving voltage waveforms described in the first exemplary embodiment and the second exemplary embodiment.

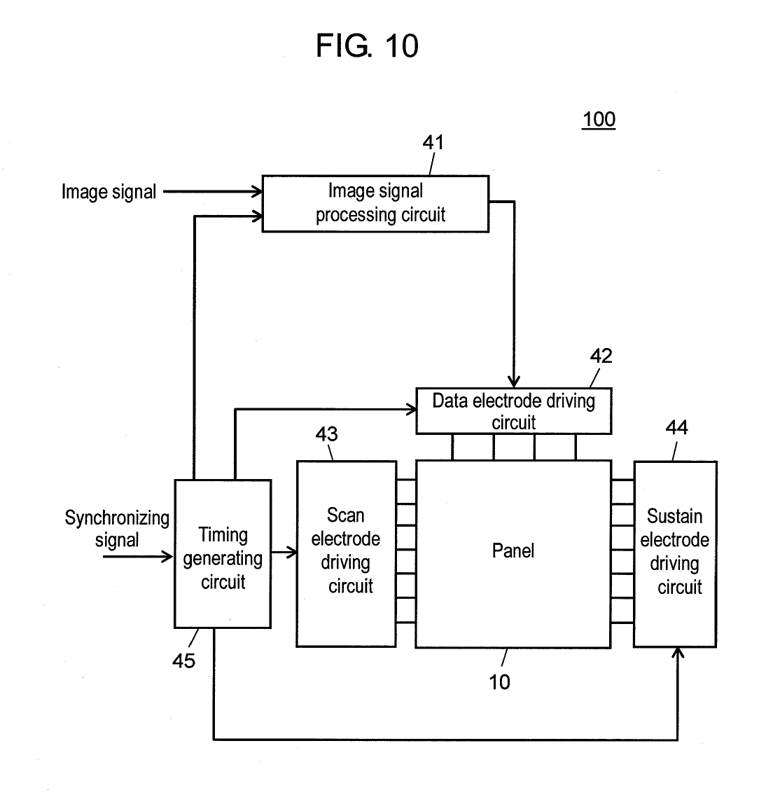

FIG. 10 is a circuit block diagram of plasma display device 100 in accordance with the first and second exemplary embodiments of the present invention. Plasma display device 100 has panel 10 and a panel driving circuit. Protective layer 26 of panel 10 has base protective layer 26a and particle layer 26b. The base protective layer is formed of a thin film containing magnesium oxide. The particle layer is formed by sticking, to base protective layer 26a, single-crystal particles 27 of magnesium oxide that have an NaCl crystal structure surrounded by specified two type orientation faces of a (100) face and a (111) face, or single-crystal particles 27 of magnesium oxide that have an NaCl crystal structure surrounded by specified three type orientation faces of a (100) face, a (110) face, and a (111) face. The panel driving circuit drives panel 10 in a manner that an initializing discharge for forming wall charge necessary for a sustain discharge is caused in the first subfield of a plurality of subfields, and an address discharge for erasing the wall charge necessary for a sustain discharge is caused in address periods of the plurality of subfields. The panel driving circuit has the following elements:

image signal processing circuit 41;

data electrode driving circuit 42;

scan electrode driving circuit 43;

sustain electrode driving circuit 44;

timing generating circuit 45; and

power supply circuits (not shown) for supplying power necessary for each circuit block.

Image signal processing circuit 41 converts input image signals into image data indicating light emission and no light emission in each subfield. Data electrode driving circuit 42 converts the image data in each subfield into a signal corresponding to each of data electrodes D1 through Dm, and drives each of data electrodes D1 through Dm. Timing generating circuit 45 generates various timing signals for controlling the operation of each circuit block according to a horizontal synchronizing signal and a vertical synchronizing signal, and supplies the timing signals to each circuit block. Scan electrode driving circuit 43 drives each of scan electrodes SC1 through SCn, according to the timing signals. Sustain electrode driving circuit 44 drives sustain electrodes SU1 through SUn, according to the timing signals.

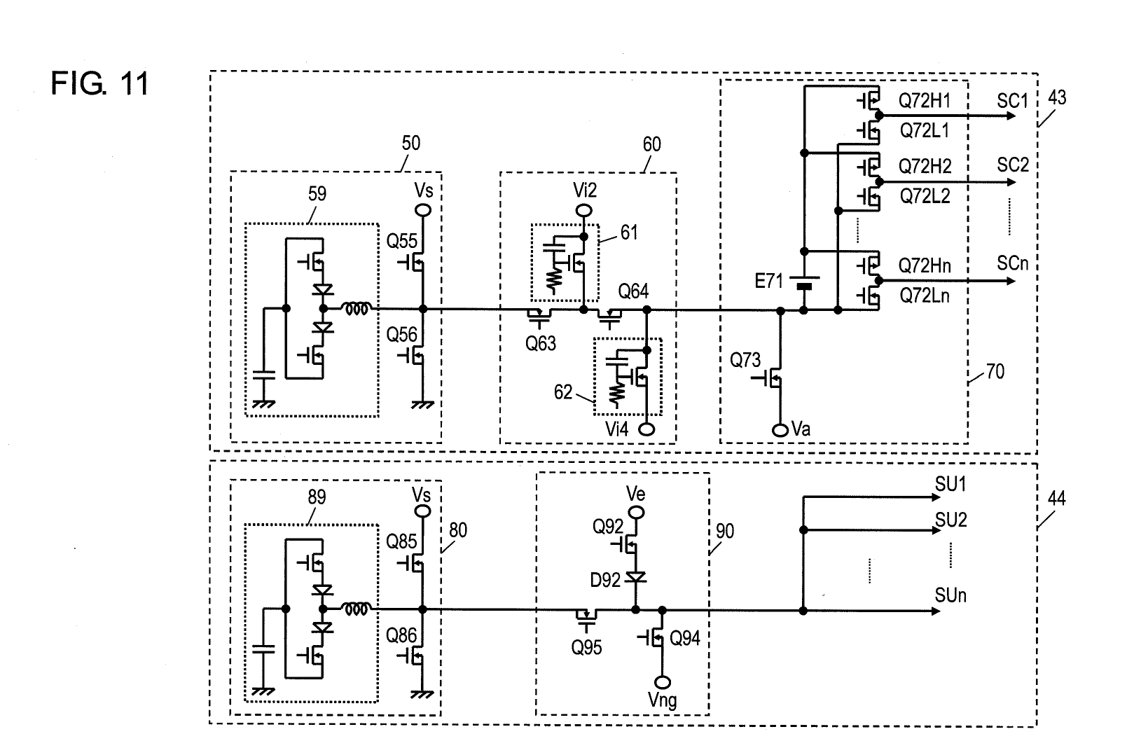

FIG. 11 is a circuit diagram of scan electrode driving circuit 43 and sustain electrode driving circuit 44 of plasma display device 100 in accordance with the first and second exemplary embodiments of the present invention.

Scan electrode driving circuit 43 has sustain pulse generating circuit 50, initializing waveform generating circuit 60, and scan pulse generating circuit 70. Sustain pulse generating circuit 50 has the following elements:

switching element Q55 for applying voltage Vs to scan electrodes SC1 through SCn;

switching element Q56 for applying 0 (V) to scan electrodes SC1 through SCn; and

power recovering section 59 for recovering power when sustain pulses are applied to scan electrodes SC1 through SCn.

Initializing waveform generating circuit 60 has Miller integrating circuit 61 for applying an up-ramp waveform voltage to scan electrodes SC1 through SCn, and Miller integrating circuit 62 for applying a down-ramp waveform voltage to scan electrodes SC1 through SCn. Switching element Q63 and switching element Q64 are disposed to prevent backflow of current via parasitic diodes, for example, of other switching elements. Scan pulse generating circuit 70 has the following elements:

floating power supply E71;

switching elements Q72H1 through Q72Hn for applying the voltage at the high-voltage side of floating power supply E71 to scan electrodes SC1 through SCn;

switching elements Q72L1 through Q72Ln for applying the voltage at the low-voltage side of the floating power supply to the scan electrodes; and

switching element Q73 for fixing the voltage at the low-voltage side of floating power supply E71 to voltage Va.

Sustain electrode driving circuit 44 has sustain pulse generating circuit 80, and initializing/address voltage generating circuit 90. Sustain pulse generating circuit 80 has the following elements:

switching element Q85 for applying voltage Vs to sustain electrodes SU1 through SUn;

switching element Q86 for applying 0 (V) to sustain electrodes SU1 through SUn; and

power recovering section 89 for recovering power when sustain pulses are applied to sustain electrodes SU1 through SUn.

Initializing/address voltage generating circuit 90 has switching element Q92 and diode D92 for applying voltage Ve to sustain electrodes SU1 through SUn, and switching element Q94 for applying voltage Vng to sustain electrodes SU1 through SUn. Switching element Q95 is disposed to prevent backflow of current via parasitic diodes, for example, of other switching elements.

These switching elements can be configured of generally known devices, such as a metal oxide semiconductor field-effect transistor (MOSFET), and an insulated gate bipolar transistor (IGBT). These switching elements are controlled, according to timing signals that are generated in timing generating circuit 45 and correspond to the switching elements.

The driving circuit of FIG. 11 is an example of a circuit configuration for generating the driving voltage waveforms of FIG. 7. The plasma display device of the present invention is not limited to this circuit configuration.

The respective specific values for use in the first and second exemplary embodiments are merely examples. It is preferable to set values optimum for the characteristics of the panel, the specifications of the plasma display device, or the like, for each case.

### INDUSTRIAL APPLICABILITY

The plasma display device of the present invention is capable of performing high-speed stable address operation, and displaying images of excellent display quality, and thus is useful as a display device.

1. A plasma display device comprising:
a plasma display panel including:
a front plate having display electrode pairs on a first glass substrate, a dielectric layer disposed so as to cover the display electrode pairs, and a protective layer disposed on the dielectric layer;
a back plate having data electrodes on a second glass substrate, the back plate being faced to the front plate; and
discharge cells formed in positions where the display electrode pairs are faced to the data electrodes; and
a panel driving circuit for driving the plasma display panel in a manner that a plurality of subfields are temporally disposed to form one field period, each of the subfields having an address period for causing an address discharge, and a sustain period for causing a sustain discharge in the discharge cells,
wherein the protective layer has:
a base protective layer formed of a thin film of a metal oxide containing at least one of magnesium oxide, strontium oxide, calcium oxide, and barium oxide; and
a particle layer formed by sticking, to the base protective layer, single-crystal particles of magnesium oxide that have an NaCl crystal structure surrounded by specified two type orientation faces of a (100) face and a (111) face, or by specified three type orientation faces of a (100) face, a (110) face, and a (111) face, and
wherein the panel driving circuit drives the plasma display panel in a manner that an initializing discharge for forming wall charge is caused in a first subfield of the plurality of subfields, and the address discharge for erasing the wall charge is caused in the address periods of the plurality of subfields.

2. The plasma display panel of claim 1, wherein the panel driving circuit drives the plasma display panel in a manner that
the display electrode pairs are divided into a plurality of display electrode pair groups,
each one of the address periods is divided into a plurality of address sub-periods corresponding to the plurality of display electrode pair groups, and
a replenish sub-period for replenishing the wall charge is disposed between one of the address sub-periods and next one of the address sub-periods.
